(19) United States
(12) Patent Application Publication
(10) Pub. No.: US 2004/0115601 A1
(43) Pub. Date: Jun. 17, 2004

(54) Grizzle number line with Kieu Wave Form

(76) Inventor: Daniel Eugene Grizzle, Overland, MO (US)

Correspondence Address: Daniel Eugene Grizzle, 9410 Romaine, OverLand, MO, 63114, US

(21) Appl. No.: 10/633,986

(22) Filed: Aug. 4, 2003

Related U.S. Application Data
(60) Provisional application No. 60/401,359, filed on Aug. 6, 2002.

(51) Int. Cl. G09B 19/02; G09B 23/02

(52) U.S. Cl. 434/188

(57) ABSTRACT

This process is for finding underlying symmetries of numbers of any magnitude through the use of a two dimensional number line, a resulting number line, a wave form, and grid layout. Then marking these numbers as possessing underlying symmetries therefore leaving the ones not marked on the Kieu Wave Form as Prime numbers of any magnitude.

### CROSS-REFERENCE TO RELATED APPLICATIONS

I am claiming reference to provisional Patent Application, application No. 60/401,359, filing date Aug. 6, 2002, confirmation number 3539.

### BACKGROUND OF THE INVENTION

Field of Invention: Mathematics

There are no known references to existing specific documents. A reference to a specific problem is generally referred to Prime numbers.

### BRIEF SUMMARY OF THE INVENTION

By using the Grizzle number Line and the Kieu wave Form associated with it, it is possible, by the use of the Symmetry of these coexisting entities to locate the position and existence of all Prime numbers.

The advantage of using the Grizzle Number Line with the associated Kieu Wave Form is the application of Symmetry to a two dimensional number line as opposed to the traditional linear number line used Mathematics.

The object of the invention is to locate the position of Prime numbers in a ‘grid’ layout pattern.

### BRIEF DESCRIPTION OF THE SEVERAL VIEWS OF THE DRAWING

FIG. 1A:

This figure shows the Grizzle Number Line. This is a two dimensional representation of the commonly known linear number line in mathematics. It depicts the number One starting at a top position that sequentially increments downward to the number seven, inclusive. This FIG. 1A may also be drawn in reverse.

FIG. 1A proceeds sequentially in multiples of seven on each row. FIG. 1A depicts the Grizzle Number Line up to and including the number 1260.

FIG. 1A also shows a linear Number Line number associated with each Column in the Grizzle Number Line. This Number Line is a direct result of dividing the 7th row of the Grizzle Number Line by seven.

FIG. 2A:

This figure shows the application of the Kieu Wave Form (Shaded areas) to the Grizzle Number Line.

The Kieu Wave Form consists of two basic rows.

Row (5) which starts at the number five and increments at the rate of six.

Row (7) which starts at the number seven and increments at the rate of six.

The Kieu Wave Form increments per column of the Grizzle Number Line by a factor of 42.

FIG. 2A represents the Kieu Wave Form up to the number 1260.

FIG. 2A shows the corresponding Number Line associated with the Grizzle Number Line.

FIG. 3A:

FIG. 3A represents the addition of the Zero to the beginning of the Number Line. Also an example list of numbers which replace the zero to represent incrementing sections of the Grizzle Number Line in grid form.

FIG. 4A:

FIG. 4A represents the Grizzle Number Line in a grid form without the Grizzle Number Line Numbers, only the Number Line.

FIG. 5A:

FIG. 5A represents the Kieu Wave Form applied to the Grizzle Number Line with the Number Line, in grid form.

FIG. 6A:

FIG. 6A shows the results of underlying symmetry applied to the Kieu Wave Form, starting from zero.

FIG. 7A:

FIG. 7A shows the results of underlying symmetry applied to the Kieu Wave Form, starting from one hundred eighty.

FIG. 8A:

FIG. 8A shows the results of underlying symmetry applied to the Kieu Wave Form, starting at twelve hundred and sixty.

### DETAILED DESCRIPTION OF THE INVENTION

The Grizzle Number Line with the associated Kieu Wave Form is designed to find Prime numbers. Because of the perfect symmetry of these entities it is the exploitation of these symmetries that accomplishes this task.

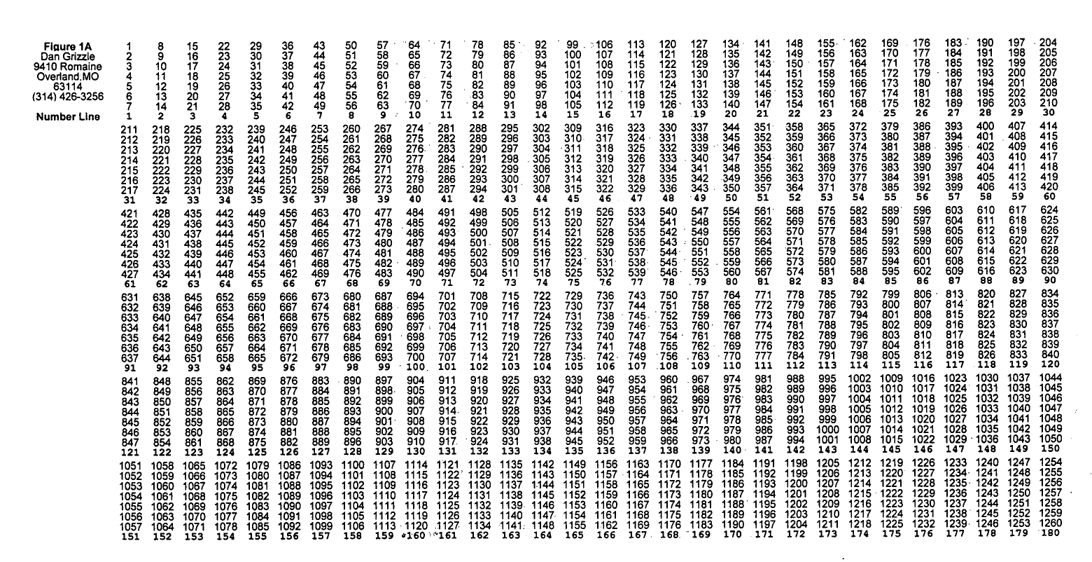

The Grizzle Number Line is infinite. As shown in FIG. 1A once the Grizzle number Line is started it will continue infinitely in multiples of seven's. Consequently the Number Line associated with the Grizzle Number Line is linear in nature but is a direct result of dividing the Grizzle Number Line row 7 by 7, which is also infinite. The Number Line will always represent exactly the number of columns on the Grizzle Number Line.

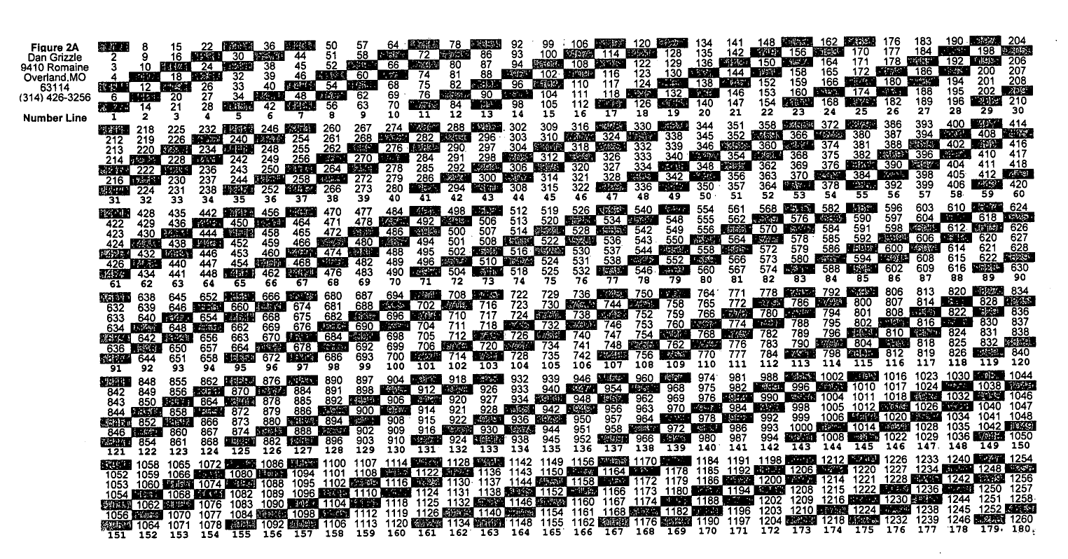

The Kieu Wave From when applied to the Grizzle Number Line also has a perfect symmetry. This symmetry is in multiples of 6. By adding 6 to the five and seven respectively the Kieu Wave Form develops on the Grizzle Number Line for as long as the Grizzle Number Line extends, which is infinite. FIG. 2A.

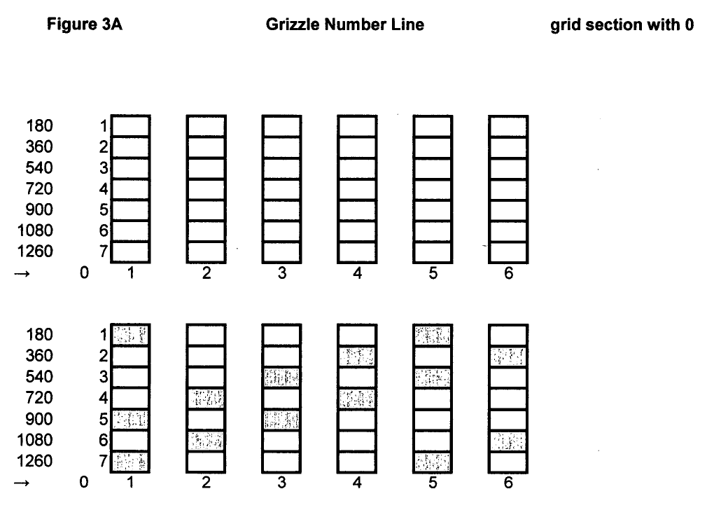

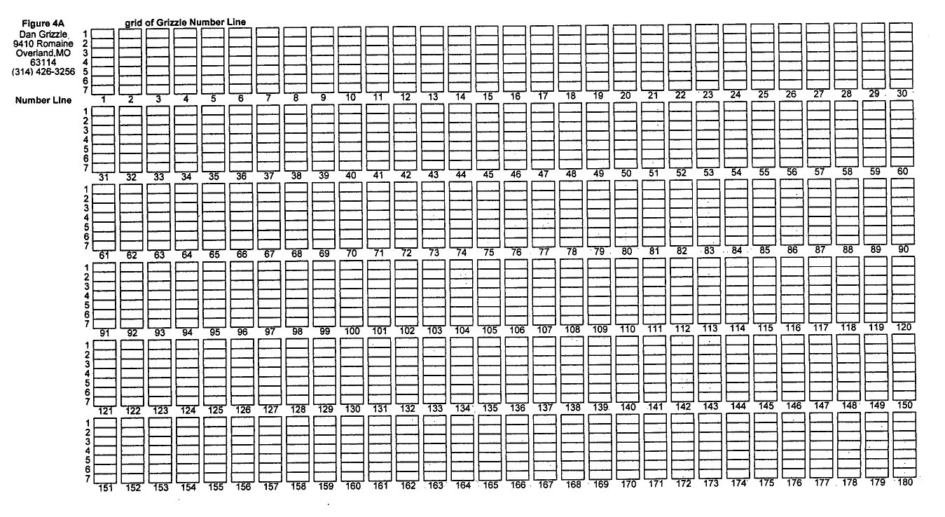

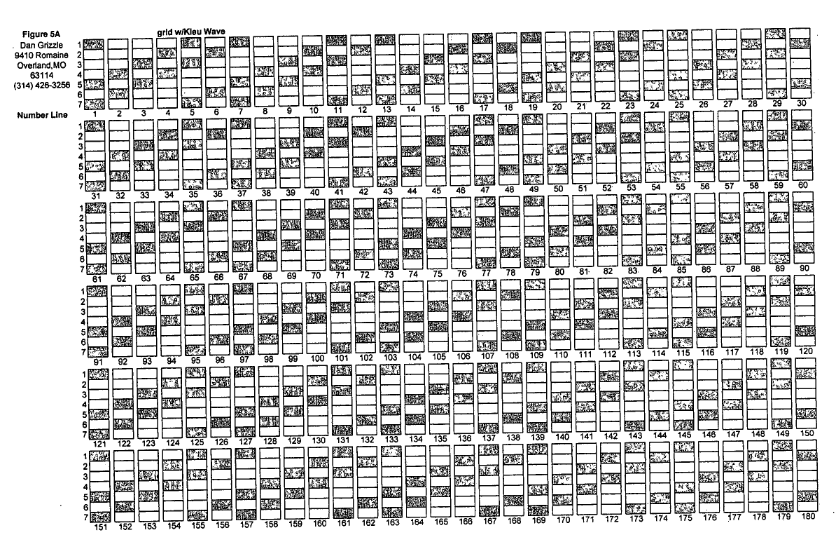

The Grizzle Number Line can be segmented into section s of 180's per the Number Line. This segmenting results in a ‘grid’ which is formed by 6 smaller sections of the Number Line in multiples of 30, which in turn these sections consist of 5 sections of the Number Line in multiples of sixes. FIG. 3A and FIG. 4A

‘Process’ of Use of the Invention

Example: (Only using numbers on the Kieu Wave Form)

| Start of | | | | |
|---|---|---|---|---|
| ‘grid’ | MOD by | Equals | Start of Symmetry | |
| 0 | 11 | 0 | 11 − 0 = 11 | 0 + 11 = 11 |
| 180 | 11 | 4 | 11 − 4 = 7 | 180 + 7 = 187 |
| 360 | 11 | 8 | 11 − 8 = 3 | 360 + 3 = 363 |
| 540 | 11 | 1 | 11 − 1 = 10 | 540 + 10 = 550 |
| 720 | 13 | 5 | 13 − 5 = 8 | 720 + 8 = 728 |
| 1260 | 23 | 18 | 23 − 18 = 5 | 1260 + 5 = 1265 |

The Process is simple. As long as the beginning ‘grid’ number that replaces the zero is a multiple of 180 then the ‘process’ just finds the MOD of this number using a Kieu Wave number. Minus that Mod from the Kieu Wave number and add it to the ‘grid’ number. Multiply this number by 7 and add or subtract the Kieu Wave number as many times as wanted. This will leave only the numbers on the Grizzle Number Line that does not have underlying symmetries (Prime numbers). (Excluding the numbers divisible by 2 or 3 which are inconsequential, they do not fall on the Kieu Wave)

The best mode contemplated by me of carrying out this invention is a small Computer program that finds the Mod of any beginning ‘grid’ number using a Kieu Wave number. Finding the start position of the underlying Kieu Wave number and marking it as having a underlying symmetry. Since there is only one ‘grid’ this is very fast. Also since one number (like the 11), once it has been marked on the ‘grid’, then no other multiple of that number need be processed. IE: 55, 187, 1111 etc.

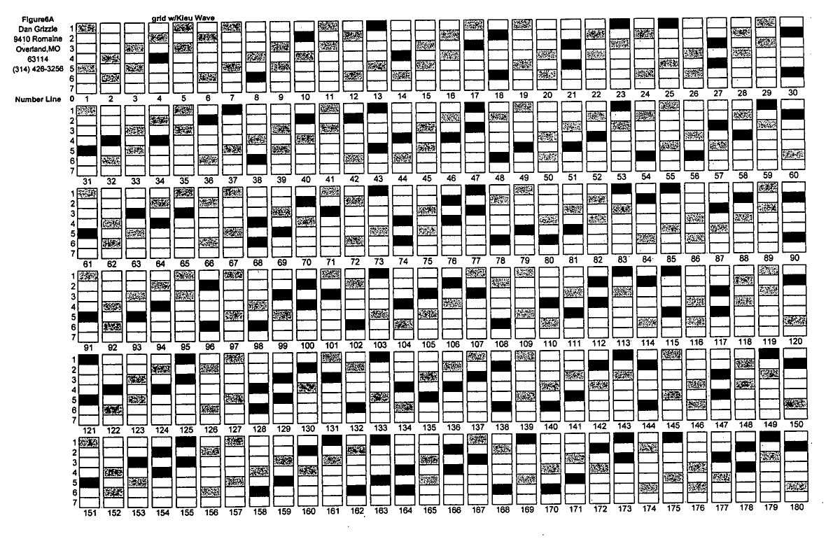

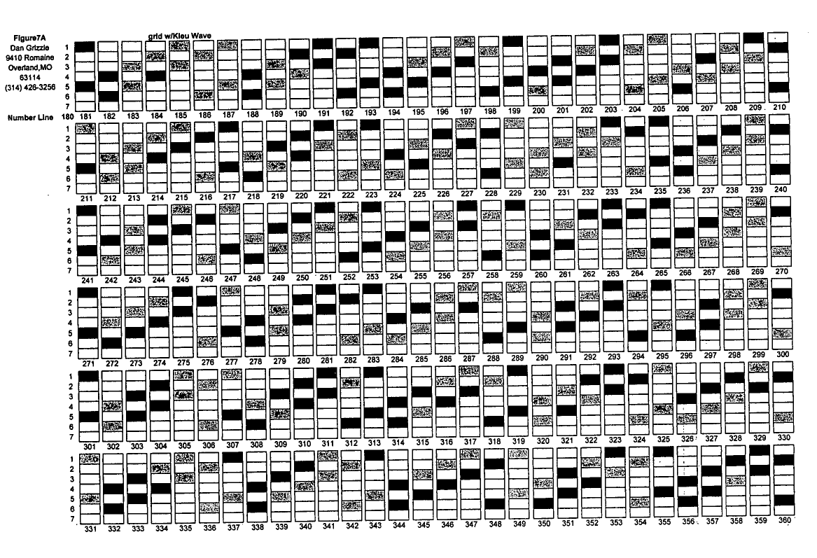

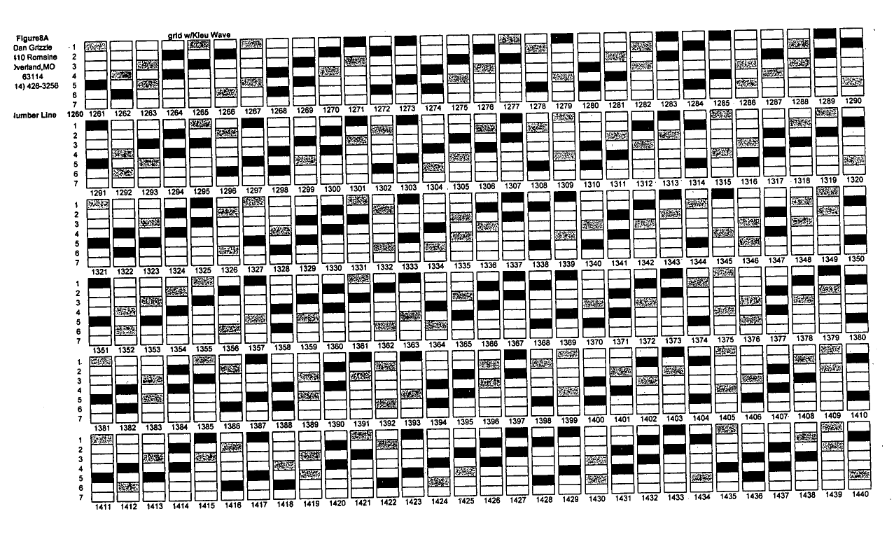

This ‘process’ can be extended across multiple ‘grids’ connected together. FIG. 6A, FIG. 7A, may be joined at the end and beginning, respectively.

1. What I claim as my invention is the arrangement of a series of numbers in a two dimensional sequential format of columns and rows called the Grizzle Number Line used for the distinct purpose of finding Prime numbers as defined in Mathematics. (FIG. 1A)
What I claim as my invention is a wave form called the Kieu Wave Form which is a series of numbers that when applied to the Grizzle Number Line are arranged in such fashion as to cause a distinct pattern in multiples of six beginning with the numbers 5 and 7 respectively. (FIG. 2A)
What I claim as my invention is that when the Grizzle Number Line is created in a series of multiples of six rows and that each row is thirty columns long that this series forms a ‘grid’.
What I claim as my invention is the use of a two dimensional number line (Grizzle Number Line) and an associated (Number Line) and associated wave form (Kieu Wave Form) and a ‘grid’ layout along with the combined Symmetry of these particular parts that this constructs a Process for finding Prime numbers and that this “Process” is a unique part of my invention.
